(19) United States
(12) Patent Application Publication
(10) Pub. No.: US 2024/0289662 A1
(43) Pub. Date: Aug. 29, 2024

(54) DYNAMIC QUANTUM INSTRUCTION FILE CUSTOMIZATION

(71) Applicant: Red Hat, Inc., Raleigh, NC (US)

(72) Inventors: Leigh Griffin, Waterford (IE); Stephen Coady, Dublin (IE)

(21) Appl. No.: 18/175,800

(22) Filed: Feb. 28, 2023

(51) Int. Cl. G06N 10/20; G06N 10/80

(52) U.S. Cl. CPC G06N 10/20; G06N 10/80

(57) ABSTRACT

It is determined that a quantum instruction file (QIF) that includes quantum programming instructions is to be submitted for execution on a quantum computing system (QCS). A function identifier is identified in the QIF that identifies a function of a plurality of functions. A programming instruction set is obtained from a configuration structure that corresponds to the QCS that, upon execution, implements the function. The configuration structure identifies a plurality of programming instruction sets written in a programming language syntax, each programming instruction set, when executed on the QCS, operable to implement a corresponding function of a plurality of different functions. The QIF is modified to include the programming instruction set to generate a modified QIF. The modified QIF is caused to be submitted to the QCS for execution in lieu of the QIF.

### BACKGROUND

Quantum computing involves the use of quantum bits, referred to herein as “qubits,” which have characteristics that differ from those of classical (e.g., non-quantum) bits used in classical computing. For example, while a classical bit may be in a state of either one (1) or zero (0), a qubit may be in a “superposition” of both states simultaneously. A pair of qubits may also experience a physical phenomenon referred to as “entanglement,” in which the quantum state of each qubit may not be described independently of the state of the other qubit.

### SUMMARY

The examples disclosed herein implement dynamic quantum instruction file (QIF) customization. A QIF customizer modifies a QIF to include programming instruction sets at locations associated with function identifiers in the QIF to generate a modified QIF. The QIF customizer causes the modified QIF to be submitted to a quantum computing system (QCS) for execution in lieu of the QIF. In this manner, the QIF may be submitted for execution on a QCS without concern for nuances between different QCSs that would require different programming instructions.

In one example a method is provided. The method includes determining, by a quantum instruction file (QIF) customizer executing on a computing device, that a first QIF comprising quantum programming instructions that comply with a first programming language syntax is to be submitted for execution on a first quantum computing system (QCS) of a plurality of QCSs. The method further includes identifying in the first QIF, by the QIF customizer, a first function identifier that identifies a first function of a plurality of functions. The method further includes obtaining, by the QIF customizer from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions. The method further includes modifying, by the QIF customizer, the first QIF to include the first programming instruction set at a location associated with the first function identifier in the first QIF to generate a first modified QIF, causing, by the QIF customizer, the first modified QIF to be submitted to the first QCS for execution in lieu of the first QIF.

In another one example a computing device is provided. The computing device includes a memory, and a processor device coupled to the memory to determine that a QIF comprising quantum programming instructions is to be submitted for execution on a QCS of a plurality of QCSs. The processor device is further to identify in the QIF a function identifier that identifies a quantum function of a plurality of quantum functions. The processor device is further to obtain, from a configuration structure, a programming instruction set that implements the quantum function. The processor device is further to modify the QIF to include the programming instruction set to generate a modified QIF. The processor device is further to cause the modified QIF to be submitted to the QCS for execution in lieu of the QIF.

In another one example a non-transitory computer-readable storage medium is provided. The non-transitory computer-readable storage medium includes executable instructions to cause a processor device to determine that a QIF comprising quantum programming instructions that comply with a programming language syntax is to be submitted for execution on a QCS of a plurality of QCSs. The executable instructions further cause the processor device to identify in the QIF a function identifier that identifies a function of a plurality of functions. The executable instructions further cause the processor device to obtain, from a configuration structure, a programming instruction set that, upon execution, implements the function, wherein the configuration structure identifies a plurality of programming instruction sets written in the programming language syntax and being operable to implement a corresponding function of a plurality of different functions. The executable instructions further cause the processor device to modify the QIF to include the programming instruction set at a location associated with the function identifier in the QIF to generate a modified QIF, cause the modified QIF to be submitted to the QCS for execution.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which dynamic customization of quantum instruction files (QIFs) can be practiced according to some implementations;

FIG. 2 is a flowchart of a method for dynamic customization of QIFs according to some implementations;

FIG. 3 is a block diagram of an environment in which customization of QIFs can be practiced according to another implementation;

FIG. 4 is a block diagram of an environment in which customization of QIFs can be practiced according to yet another implementation;

FIG. 5 is a block diagram of a computing device suitable for implementing customization of QIFs according to one implementation;

FIG. 6 is a block diagram of a computing device suitable for implementing customization of QIFs according to one implementation;

FIG. 7 is a simplified block diagram of the environment illustrated in FIG. 1 according to one implementation; and

FIG. 8 is a block diagram of a computing device 12 suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Quantum computing systems are finite resources and may be heavily utilized. Some computing environments have access to multiple quantum computing systems. Prior to submission of a quantum instruction file (QIF) to a quantum computing system (QCS) the QIF may need to be customized for the particular QCS due to nuances of the particular QCS. For example, obtaining access to a qubit, reading a qubit, causing entanglement of qubits, putting a qubit into a state of superposition, invoking a particular service, may all differ from QCS to QCS depending on any number of factors, including, by way of non-limiting example, the manufacturer of the QCS, the types of qubits implemented by the QCS, the particular operating system (OS) used the QCS, and the like. Having to customize a QIF based on a particular QCS can be time-consuming and fraught with the likelihood of introducing errors as changes are made to the QIF.

The examples disclosed herein implement dynamic QIF customization. A QIF customizer determines that a QIF file is to be submitted to a first QCS of a plurality of QCSs. The QIF customizer analyzes the QIF to identify function identifiers that identify corresponding functions, such as reading a qubit, allocating a qubit, querying a service, or the like. The QIF customizer obtains from a configuration structure that corresponds to the first QCS, programming instruction sets that, when executed, are operable to implement the corresponding function on the first QCS. The QIF customizer modifies the QIF to include the programming instruction sets at locations associated with the function identifiers in the QIF to generate a modified QIF. The QIF customizer causes the modified QIF to be submitted to the first QCS for execution in lieu of the first QIF. In this manner, the QIF may be submitted for execution on a QCS without concern regarding nuances between different QCSs that would require different programming instructions. Moreover, the developer of the QIF need only write the QIF once without having to learn the nuances of a variety of different QCSs. Rather, the developer need only learn which function identifiers correspond to which desired functions, and the actual programming instructions necessary to carry out the desired function on a particular QCS will be provided during the dynamic customization implemented by the QIF customizer.

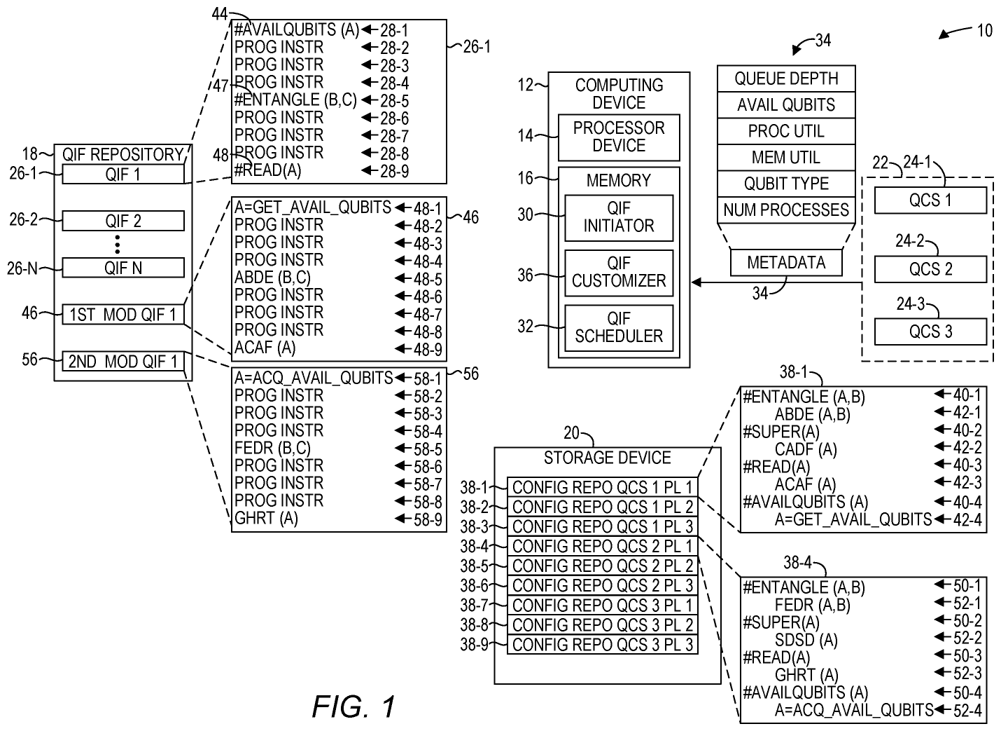

FIG. 1 is a block diagram of an environment 10 in which dynamic customization of QIFs can be practiced. The environment 10 includes a computing device 12 that in turn includes a processor device 14 and a memory 16. The computing device 12 is communicatively coupled to a QIF repository 18 and storage device 20. The computing device 12 is communicatively coupled to a group 22 of QCSs 24-1-24-3 (generally QCSs 24). The QCSs 24 operate in a quantum environment but can operate using classical computing principles or quantum computing principles. When using quantum computing principles, the QCSs 24 perform computations that utilize quantum-mechanical phenomena, such as superposition and entanglement. The QCSs 24 may operate under certain environmental conditions, such as at or near 0° Kelvin. When using classical computing principles, the QCSs 24 utilize binary digits that have a value of either 1 or 0.

The QIF repository 18 stores a plurality of QIFs 26-1-26-N (generally, QIFs 26). Each QIF 26 is written in a programming language syntax that is associated with a particular quantum computing programming language. By way of non-limiting example, the QIF 26-1 may be written in a programming language syntax associated with Q #, Python, QISKIT, or the like. Each QIF 26 includes one or more function identifiers, each of which identifies a particular function. The term “function” as used herein refers to a desired processing step or steps on a QCS 24. A function may comprise, by way of non-limiting example, obtaining access to a qubit, reading/measuring a qubit, causing entanglement of qubits, invoking a particular service, obtaining certain system information, or the like. The functions are those processes that may require different programming statements on different QCSs, even for QIFs 26 written in a same programming language syntax.

A function identifier may comprise, for example, a predefined sequence of characters. As an example, line 28-1 of the QIF 26-1 comprises a function identifier “#AVAILQUBITS (A)” and corresponds to a QCS function of providing information on the number of available qubits on the respective QCS 24. Lines 28-2-28-4 of the QIF 26-1 comprise regular programming instructions written in the particular programming language syntax. Such programming instructions do not differ irrespective of the QCS 24. Line 28-5 comprises a function identifier “#ENTANGLE (B,C)” and corresponds to a QCS function of causing two qubits to become entangled. Lines 28-6-28-8 comprise regular programming instructions written in the particular programming language syntax. Line 28-9 comprises a function identifier “#READ(A)” and corresponds to a QCS function of determining a value of a qubit.

In this implementation, the computing device 12 includes a QIF initiator 30 that operates to submit a QIF 26 to a QIF scheduler 32. The QIF initiator 30 may be a classical computing process that performs both classical processing steps and, when needed, uses a QIF 26 to obtain results from a QCS 24. Alternatively, the QIF initiator 30 may be a special purpose program that has a primary function of submitting QIFs 26 to the QIF scheduler 32 upon the occurrence of some event, such as a user-initiated or programmatic request to do so, for example. While for purposes of illustration only one QIF initiator 30 is depicted, there may be any number of QIF initiators 30 executing concurrently, each of which may periodically, intermittently or upon the occurrence of some event submit a QIF 26 to the scheduler 32.

The scheduler 32 receives a reference to the QIF 26 from the QIF initiator 30 and selects, based on some criterion or criteria, a QCS 24 to which the QIF scheduler 32 will submit the QIF 26 (or a modified version thereof, as discussed in greater detail below) for execution. The scheduler 32 may periodically obtain QCS metadata 34 from each of the QCSs 24 to aid in the selection of a QCS 24 for a particular QIF 26. The QCS metadata 34 may include, by way of non-limiting example, for each QCS 24, a current queue depth of QIFs 26 awaiting execution, a quantity of available qubits, a current processor utilization, a current memory utilization, a type of qubit implemented on the QCS 24, and a number of user processes currently executing on the QCS 24.

The QIF scheduler 32 selects a QCS 24 for execution of the QIF 26. The selection may be based on one or more of the QCS metadata 34 and/or on other criteria, such as metadata associated with the QIF 26 that identifies certain characteristics of a QCS 24 that are suitable for executing the QIF 26, and/or requirements of the QIF 26, such as a minimum number of qubits, a certain type of qubit, a particular type of error correction implemented by the QCS 24, a minimum amount of available memory, and the like.

The QIF scheduler 32 provides the QIF customizer 36 information identifying a location of the QIF 26 and information that identifies the QCS 24 that has been selected for execution of the QIF 26. The QIF customizer 36, based on the indication from the QIF scheduler 32 that the QIF 26 is to be submitted for execution on a particular QCS 24 of the plurality of QCSs 24, processes the QIF 26 and identifies one or more function identifiers in the QIF 26.

The storage device 20 comprises a plurality of configuration structures 38-1-38-9 (generally, configuration structures 38), each of which corresponds to a particular QCS 24 and a particular programming language of a plurality of different programming languages. In this example, the configuration structures 38 comprise files. Each configuration structure 38 comprises instruction sets that, upon execution, implement a particular function, sometimes referred to herein as a quantum function, that corresponds to a particular function identifier. The QIF customizer 36, based on the programming language that corresponds to the QIF 26 and the particular QCS 24 to which the QIF 26 will be submitted for execution, selects a particular configuration structure 38. The QIF customizer 36 modifies the QIF 26 to include the programming instruction sets that correspond to the function identifiers to generate a modified QIF 26. The QIF customizer 36 then informs the QIF scheduler 32 that the modified QIF 26 is to be submitted to the QCS 24 in lieu of the QIF 26. The QIF scheduler 32 then submits the modified QIF 26 to the QCS 24 for execution.

As an example of dynamic QIF customization, assume, for purposes of illustration, that the QIF initiator 30 determines that the QIF 26-1 is to be submitted to the QIF scheduler 32 for submission to a QCS 24. In this example, the QIF initiator 30 is a classical computing process that performs certain computations using classical computing but utilizes the QIF 26-1 to perform a quantum computation on a QCS 24 because the quantum computation can be performed in a much shorter timeframe than it would otherwise take to perform on a classical computing device. The QIF initiator 30 sends a reference to the QIF 26-1 to the QIF scheduler 32.

The QIF scheduler 32 analyzes recent QCS metadata 34 received from the QCSs 24, and/or requests new QCS metadata 34 from the QCSs 24, and based on the QCS metadata 34 determines that the QCS 24-1 currently has a lowest queue depth, and a largest number of available qubits. The QIF scheduler 32 sends a reference to the QIF 26-1 and an identifier of the QCS 24-1 to the QIF customizer 36. The QIF customizer 36 accesses the QIF 26-1 and determines that the QIF 26-1 has been written in a particular programming language PL 1 and thus has been written to comply with the programming instruction syntax of the programming language PL 1. The QIF customizer 36 may make this determination by, for example, accessing a suffix of the filename of the QIF 26-1, or accessing metadata associated with the QIF 26-1 that indicates that the QIF 26-1 is written in the programming language PL 1.

The QIF customizer 36 determines that the configuration structure 38-1 corresponds to the QCS 24-1 and to the programming language PL 1. Note that the configuration structure 38-2 corresponds to the QCS 24-1 and to the programming language PL 2, and that the configuration structure 38-3 corresponds to the QCS 24-1 and to the programming language PL 3. The configuration structure 38-1 identifies four function identifiers 40-1-40-4, and four corresponding instruction sets 42-1-42-4 that, when executed, are operable to implement the corresponding function on the QCS 24-1. It is noted that, while only four function identifiers and corresponding instruction sets are illustrated, a configuration structure 38 may have tens or hundreds of different function identifiers and corresponding instruction sets.

The QIF customizer 36 accesses the QIF 26-1 and parses the contents of the QIF 26-1. The QIF customizer 36 may, for example, contain a list of all function identifiers. Each function identifier may comprise a predefined sequence of characters. The QIF customizer 36 may determine whether the QIF 26-1 contains the predefined sequence of characters of any of the function identifiers. In some examples, the QIF customizer 36 may use pattern matching algorithms, such as REGEX, to identify the predefined sequence of characters. The QIF customizer 36 determines that line 28-1 comprises a function identifier 44. The QIF customizer 36 accesses the configuration structure 38-1 and determines that the instruction set 42-4 corresponds to the function identifier 44. The QIF customizer 36 generates a new QIF 46, which will be a modified version of the QIF 26-1. The QIF customizer 36 generates a line 48-1 in the QIF 46 by replacing the function identifier 44 with the instruction set 42-4. Note that the function identifier 44 includes a variable A and the instruction set 42-4 includes a placeholder X in anticipation of the function identifier 44 containing a variable. The QIF customizer 36 replaces the variable X identified in the instruction set 42-4 with the variable A identified in the function identifier 44. In some implementations, the function identifiers may include a special character, such as a “%” which denotes a comment in a particular programming language syntax that is not to be executed. Rather than replace the function identifier with the corresponding instruction set, the QIF customizer 36 may insert the corresponding instruction set in a new line immediately after the function identifier.

The QIF customizer 36 inserts the lines 28-2-28-4 in the QIF 46 as lines 48-2-48-4. The QIF customizer 36 determines that line 28-5 comprises a function identifier 47. The QIF customizer 36 accesses the configuration structure 38-1 and determines that the instruction set 42-1 corresponds to the function identifier 47. The QIF customizer 36 generates a line 48-5 by replacing the function identifier 47 with the instruction set 42-1. The QIF customizer 36 inserts the lines 28-5-28-8 in the QIF 46 as lines 48-5-48-8. The QIF customizer 36 determines that line 28-9 comprises a function identifier 48. The QIF customizer 36 accesses the configuration structure 38-1 and determines that the instruction set 42-3 corresponds to the function identifier 48. The QIF customizer 36 generates a line 48-9 by replacing the function identifier 48 with the instruction set 42-3. The QIF customizer 36 then causes the modified QIF 46 to be submitted to the QCS 24-1 in lieu of the QIF 26-1. In one example, the QIF customizer 36 sends a message to the QIF scheduler 32 with information that identifies the QIF 46, such as a reference to the QIF 46. The QIF scheduler 32 accesses the QIF 46 and submits the QIF 46 to the QCS 24-1 for execution.

As another example, assume at a subsequent point in time, the QIF initiator 30 determines that the QIF 26-1 is again to be submitted to the QIF scheduler 32 for submission to a QCS 24. The QIF scheduler 32 analyzes recent QCS metadata 34 received from the QCSs 24, and/or requests new QCS metadata 34 from the QCSs 24, and based on the QCS metadata 34 determines that the QIF 26-1 is to be submitted to the QCS 24-2. The QIF scheduler 32 sends a reference to the QIF 26-1 and an identifier of the QCS 24-2 to the QIF customizer 36. The QIF customizer 36 accesses the QIF 26-1 and determines that the QIF 26-1 has been written in the particular programming language PL 1.

The QIF customizer 36 determines that the configuration structure 38-4 corresponds to the QCS 24-2 and to the programming language PL 1. The configuration structure 38-1 identifies four function identifiers 50-1-50-4, and four corresponding instruction sets 52-1-52-4 that, when executed, are operable to implement the corresponding function on the QCS 24-2.

The QIF customizer 36 accesses the QIF 26-1 and parses the contents of the QIF 26-1. The QIF customizer 36 determines that line 28-1 comprises the function identifier 44. The QIF customizer 36 accesses the configuration structure 38-4 and determines that the instruction set 52-4 corresponds to the function identifier 44. The QIF customizer 36 generates a new QIF 56, which will be a modified version of the QIF 26-1. The QIF customizer 36 generates a line 58-1 in the QIF 56 by replacing the function identifier 44 with the instruction set 52-4.

The QIF customizer 36 inserts the lines 28-2-28-4 in the QIF 56 as lines 58-2-58-4. The QIF customizer 36 determines that line 28-5 comprises the function identifier 47. The QIF customizer 36 accesses the configuration structure 38-4 and determines that the instruction set 52-1 corresponds to the function identifier 47. The QIF customizer 36 generates a line 58-5 by replacing the function identifier 47 with the instruction set 52-1. The QIF customizer 36 inserts the lines 28-5-28-8 in the QIF 56 as lines 58-5-58-8. The QIF customizer 36 determines that line 28-9 comprises the function identifier 48. The QIF customizer 36 accesses the configuration structure 38-4 and determines that the instruction set 52-3 corresponds to the function identifier 48. The QIF customizer 36 generates a line 58-9 by replacing the function identifier 48 with the instruction set 52-3. The QIF customizer 36 then causes the modified QIF 56 to be submitted to the QCS 24-2 in lieu of the QIF 26-1. For example, the QIF customizer 36 sends a message to the QIF scheduler 32 with a reference to the QIF 56. The QIF scheduler 32 accesses the QIF 56 and submits the QIF 56 to the QCS 24-2 for execution.

In some implementations, the QIF scheduler 32 may not send the QIF 26-1 to the QIF customizer 36 until it is time to submit the QIF 26-1 to the QCS 24-2. The QIF customizer 36, rather than communicating with the QIF scheduler 32 to cause the QIF 56 to be submitted to the QCS 24-2, may send the QIF 56 to the QCS 24-2 directly.

It is noted that, because the QIF initiator 30, the QIF customizer 36 and the QIF scheduler 32 are components of the computing device 12, functionality implemented by the QIF initiator 30, the QIF customizer 36 and the QIF scheduler 32 may be attributed to the computing device 12 generally. Moreover, in examples where the QIF initiator 30, the QIF customizer 36 and the QIF scheduler 32 comprises software instructions that program the processor device 14 to carry out functionality discussed herein, functionality implemented by the QIF initiator 30, the QIF customizer 36 and the QIF scheduler 32 may be attributed herein to the processor device 14.

It is further noted that for purposes of illustration the components discussed herein, such as the QIF initiator 30, the QIF customizer 36 and the QIF scheduler 32 are shown as executing on a single computing device 12, in other embodiments the components may execute on different computing devices 12. In fact, in some implementations, there may be any number of QIF initiators 30 executing on any number of computing devices 12.

In some implementations the QIF customizer 36 may periodically query the QCS 24-1-24-3 to obtain information about the QCSs 24-1-24-3 that may impact the contents of a configuration structure 38. For example, a function identifier in a QIF 26 may refer to a particular functional process of a QCS 24 that the QCS 24 may change from time to time, thereby causing a change in the instruction set that corresponds to the function identifier. As an example, at one point in time a QCS 24 may utilize a certain error correction process when the QCS 24 has a certain temperature profile, and a different error correction process when the QCS 24 has a different temperature profile. The error correction process invocations may differ from one another. The QIF customizer 36 may, via information obtained from the QCS 24 determine that the QCS 24 has switched from a first error correction process to a second error correction process. The QIF customizer 36 may then modify the instructions sets contained in the configuration structures 38 so that subsequent use of the configuration structures 38 to generate modified QIFs 26 utilize an instruction set that will invoke the second error correction process rather than the first error correction process.

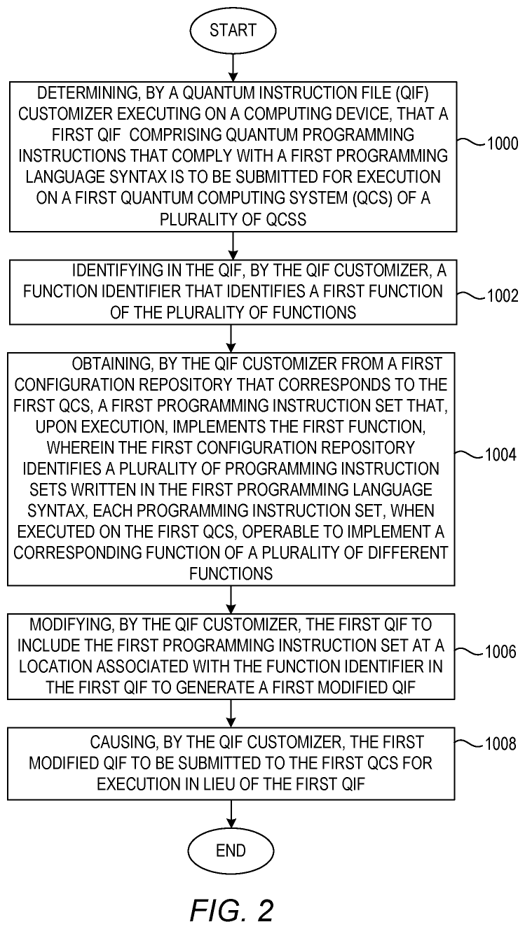

FIG. 2 is a flowchart of a method for dynamic customization of QIFs according to some implementations. FIG. 2 will be discussed in conjunction with FIG. 1. The QIF customizer 36 determines that the QIF 26-1, comprising quantum programming instructions that comply with a programming language syntax, is to be submitted for execution on the QCS 24-1 of the plurality of QCSs 24-1-24-3 (FIG. 2, block 1000). The QIF customizer 36 identifies in the QIF 26-1 the function identifier 44 that identifies a function of a plurality of functions (FIG. 2, block 1002). The QIF customizer 36 obtains, from the configuration structure 38-1 that corresponds to the QCS 24-1, the programming instruction set 42-4 that, upon execution, implements the function, wherein the configuration structure 38-1 identifies a plurality of programming instruction sets 42-1-42-4 written in the programming language syntax, each programming instruction set 42, when executed on the QCS 24-1, operable to implement a corresponding function of the plurality of different functions (FIG. 2, block 1004). The QIF customizer 36 modifies the QIF 26-1 to include the programming instruction set 42-4 at a location associated with the function identifier 44 in the QIF 26-1 to generate the modified QIF 46 (FIG. 2, block 1006). The QIF customizer 36 causes the modified QIF 46 to be submitted to the QCS 24-1 for execution in lieu of the QIF 26-1 (FIG. 2, block 1008).

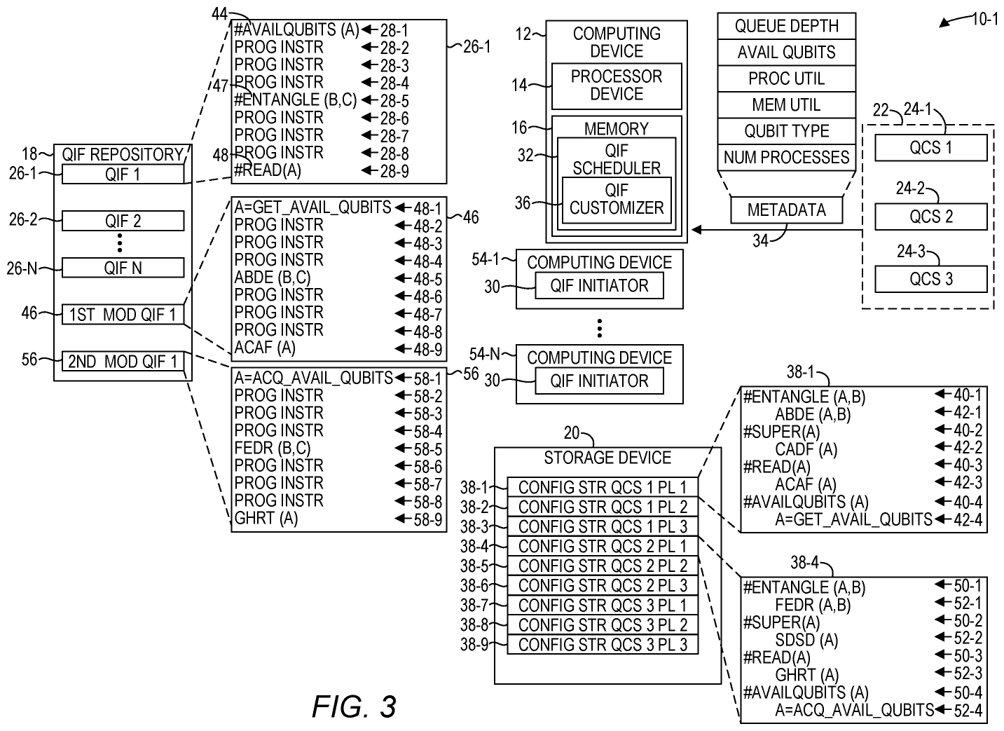

FIG. 3 is a block diagram of an environment 10-1 in which customization of QIFs can be practiced according to another implementation. The environment 10-1 is substantially similar to the environment 10 discussed above with reference to FIG. 1 except as otherwise noted herein. In this implementation the QIF customizer 36 is a component of the QIF scheduler 32. A plurality of computing devices 54-1-54-N each include a QIF initiator 30 that that operate to submit QIFs 26 to the QIF scheduler 32. The QIF scheduler 32 receives a QIF 26 and selects, as discussed above with regard to FIG. 1, a QCS 24 to which the QIF scheduler 32 will submit a modified version of the QIF 26 for execution. The QIF scheduler 32 provides the QIF customizer 36 information identifying a location of the QIF 26 and information that identifies the QCS 24 that has been selected for execution of the QIF 26. The QIF customizer 36 modifies the QIF 26, as discussed above with regard to FIG. 1, and the QIF scheduler 32 submits the modified QIF 26 to the selected QCS 24.

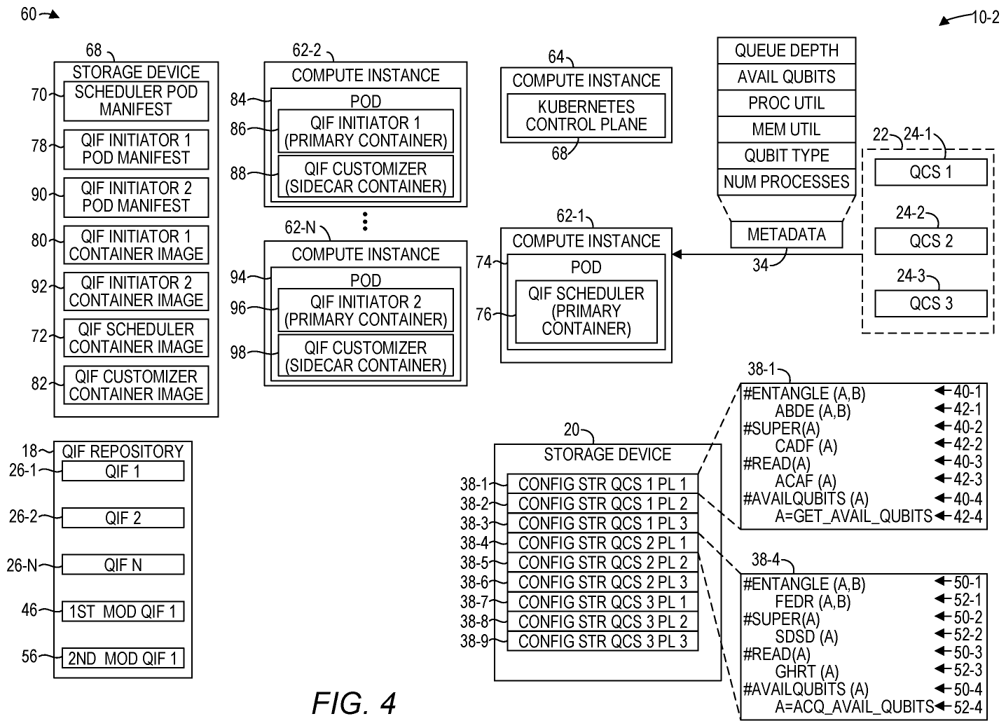

FIG. 4 is a block diagram of an environment 10-2 in which customization of QIFs can be practiced according to another implementation. The environment 10-2 is substantially similar to the environment 10 discussed above with reference to FIG. 1 except as otherwise noted herein. In this example, the environment 10-2 is a containerized environment wherein a container orchestration system 60 causes the instantiation of containers on one or more of a plurality of compute instances 62-1-62-N (generally, compute instances 62). The term “compute instance” as used herein refers to a computing device, or a virtual machine executing on a computing device. The phrase “container image” as used herein refers to a static package of software comprising one or more layers, the layers including everything needed to run an application (i.e., as a container) that corresponds to the container image, including, for example, one or more of executable runtime code, system tools, system libraries and configuration settings. A Docker® image is an example of a container image. The phrase “container” as used herein refers to a running process that is initiated, instantiated, or otherwise executed from a container image.

Container orchestration systems automate the deployment, scaling, and management of containers among a cluster of compute instances 62 (sometimes referred to as “nodes”). In this example, the container orchestration system 60 comprises the Kubernetes container orchestration system, available at Kubernetes.io; however, the examples disclosed herein may be implemented in any Kubernetes-based container orchestration system, such as, by way of non-limiting example, the Amazon® elastic container service (ECS), the Google® Kubernetes engine, the Azure™ Kubernetes service, the Oracle® cloud infrastructure container engine for Kubernetes, or the like.

The compute instances 62 each have at least one processor device and a memory, not illustrated due to spatial constraints. A controller node compute instance 64 includes a control plane 66 that is responsible for the overall management of the containers initiated on the compute instances 62. The control plane 66 represents, for example, an application programming interface (API) server, etcd, scheduler, and controller manager components of Kubernetes. While not illustrated, the compute instances 62 include control plane orchestration agents, such as kubelets and kube-proxies, which coordinate with the control plane 66 to manage the lifecycle of containers on the computes instances 62.

Kubernetes implements a resource referred to as a pod within which one or more containers execute. Containers within the same pod may have access to the same file volume(s), network interface(s), memory and the like. A pod may have one container or more than one container. A pod is defined by a pod specification, or manifest, which is essentially a configuration file that identifies attributes of the pod, including an identification of container image(s) to be executed in the pod when the pod is initiated. Generally, the control plane 66 accesses a pod manifest in response to some event, such as a user or programmatic request, selects a particular compute instance 62 on which to initiate the pod, and then causes the pod to be initiated on the selected compute instance 62 via interactions with control plane components that execute on the selected compute instance 62.

In this example, a storage device 68 contains a scheduler pod manifest 70 that identifies a QIF scheduler container image 72 that, when initiated as a container, implements the functionality of the QIF scheduler 32 as discussed above. The control plane 66 accesses the scheduler pod manifest 70 and selects the compute instance 62-1 for initiation of the pod. The control plane 66 interacts with a control plane component on the compute instance 62-1 to cause a pod 74 to be initiated on the compute instance 62-1. The scheduler pod manifest 70 identifies the QIF scheduler container image 72, and thus, the control plane 66 causes a QIF scheduler container 76 to be initiated in the pod 74.

In this example, the control plane 66 determines that a QIF initiator 1 pod manifest 78 is to be initiated. The QIF initiator 1 pod manifest 78 identifies a QIF initiator 1 container image 80 that is to be initiated as a container. The control plane 66 accesses the QIF initiator 1 pod manifest 78. In this example, an auto-injection implementation will be discussed. In particular, the control plane 66 analyzes the QIF initiator 1 pod manifest 78 to determine if the QIF initiator 1 pod manifest 78 should be dynamically modified to include a QIF customizer container image 82 that implements the functionality of the QIF customizer 36, as discussed above. Any suitable mechanism may be used to inform the control plane 66 to dynamically modify the QIF initiator 1 pod manifest 78 to include the QIF customizer container image 82. In one implementation, the QIF initiator 1 pod manifest 78 may include a predefined label, such as “QUANTUM”, or a variable may be set to a predetermined value. The control plane 66 may, prior to causing a pod manifest to be initiated, analyze the pod manifest to determine if the pod manifest contains the predefined label, and if so, automatically insert into the pod manifest suitable instructions to cause the initiation of the QIF customizer container image 82.

In this example, the control plane 66 determines that the QIF initiator 1 pod manifest 78 is to be dynamically modified to cause the initiation of the QIF customizer container image 82. The control plane 66 dynamically modifies the QIF initiator 1 pod manifest 78 to include instructions to initiate the QIF customizer container image 82, and selects the compute instance 62-2. The control plane 66 interacts with a control plane component on the compute instance 62-2 to cause a pod 84 to be initiated on the compute instance 62-1. The QIF initiator 1 pod manifest 78 identifies the QIF initiator 1 container image 80, and thus, the control plane 66 causes a QIF initiator 1 container 86 to be initiated in the pod 84. The QIF initiator 1 pod manifest 78 also identifies the QIF customizer container image 82 due to the dynamic modification of the QIF initiator 1 pod manifest 78, and thus the control plane 66 causes a QIF customizer container 88 to be initiated in the pod 84.

The QIF customizer container 88 may be referred to herein as a “sidecar container”. A sidecar container typically provides support to a primary container in a pod. The primary container in this example is the QIF initiator 1 container 86. The QIF customizer container 88 may provide the support either by directly interacting with the QIF initiator 1 container 86, or by indirectly interacting with the QIF initiator 1 container 86 such that the existence of the QIF customizer container 88 may be transparent to the QIF initiator 1 container 86. Examples of both direct and indirect communications between the QIF initiator 1 container 86 and the QIF customizer container 88 will be discussed below.

In this example, the control plane 66 also determines that a QIF initiator 2 pod manifest 90 is to be initiated. The QIF initiator 2 pod manifest 90 identifies a QIF initiator 2 container image 92 that is to be initiated as a container. The control plane 66 accesses the QIF initiator 2 pod manifest 90. The control plane 66 determines that the QIF initiator 2 pod manifest 90 is to be dynamically modified to cause the initiation of the QIF customizer container image 82 as a sidecar container. The control plane 66 dynamically modifies the QIF initiator 2 pod manifest 90 to include instructions to initiate the QIF customizer container image 82, and selects the compute instance 62-N. The control plane 66 interacts with a control plane component on the compute instance 62-N to cause a pod 94 to be initiated on the compute instance 62-N. The QIF initiator 2 pod manifest 90 identifies the QIF initiator 2 container image 92, and thus, the control plane 66 causes a QIF initiator 2 container 96 to be initiated in the pod 94. The QIF initiator 2 pod manifest 90 also identifies the QIF customizer container image 82 due to the dynamic modification of the QIF initiator 2 pod manifest 90, and thus the control plane 66 causes a QIF customizer container 98 to be initiated in the pod 94.

Assume for purposes of illustration that during execution the QIF initiator 1 container 86 determines that the QIF 26-1 is to be submitted to the QIF scheduler container 76. In a first example where the QIF initiator 1 container 86 has been programmed to assume the existence of the QIF customizer container 88, the QIF initiator 1 container 86 may send a message to the QIF customizer container 88 with a reference to the QIF 26-1. The QIF customizer container 88 may then send a reference to the QIF 26-1 to the QIF scheduler container 76. The QIF scheduler container 76 operates as discussed above with regard to the QIF scheduler 32 and selects the QCS 24-1 for execution of the QIF 26-1. The QIF scheduler container 76 provides the QIF customizer container 88 information identifying the QCS 24-1 that has been selected for execution of the QIF 26-1.

The QIF customizer container 88, based on the indication from the QIF scheduler container 76 that the QIF 26-1 is to be submitted for execution on the QCS 24-1 of the plurality of QCSs 24, processes the QIF 26-1 and identifies the function identifiers 44, 47 and 48 in the QIF 26-1. The QIF customizer container 88 modifies the QIF 26-1 to include the programming instruction sets from the configuration structure 38-1 that correspond to the function identifiers 44, 47 and 48 to generate the modified QIF 46. The QIF customizer container 88 then informs the QIF scheduler container 76 that the modified QIF 46 is to be submitted to the QCS 24 in lieu of the QIF 26-1. The QIF scheduler container 76 then submits the modified QIF 46 to the QCS 24-1 for execution.

In a second example where the QIF initiator 1 container 86 has not been programmed to assume the existence of the QIF customizer container 88, the QIF customizer container 88 interacts with the QIF scheduler container 76 to cause the generation of a modified QIF 26 in a manner that is transparent to the QIF initiator 1 container 86. In one example, the QIF customizer container 88 is programmed to intercept communications between the QIF initiator 1 container 86 and the QIF scheduler container 76. The QIF initiator 1 container 86 sends a message to the QIF scheduler container 76 with a reference to the QIF 26-1. The QIF customizer container 88 intercepts the message and inhibits the message from being sent to the QIF scheduler container 76. The QIF customizer container 88 then interacts with the QIF scheduler container 76 as discussed above to cause the modified QIF 46 to be submitted to the QCS 24 for execution.

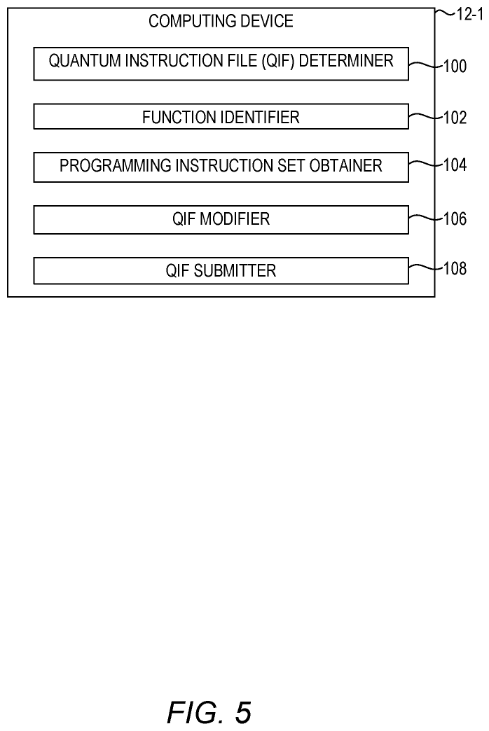

FIG. 5 is a block diagram of an environment 10-2 in which customization of QIFs can be practiced according to another implementation. The environment 10-2 is substantially similar to the environment 10 discussed above with reference to FIG. 1 except as otherwise noted herein.

FIG. 5 is a block diagram of a computing device 12-1 according to another implementation. The computing device 12-1 implements identical functionality as that described above with regard to the computing device 12. The computing device 12-1 includes a QIF determiner 100 that is operable to determine that a first QIF comprising quantum programming instructions that comply with a first programming language syntax is to be submitted for execution on a first QCS of a plurality of QCSs. The QIF determiner 100 may comprise executable software instructions configured to program a processor device to implement the functionality of determining that a first QIF comprising quantum programming instructions that comply with a first programming language syntax is to be submitted for execution on a first QCS of a plurality of QCSs, may comprise circuitry including, by way of non-limiting example, an application-specific integrated circuit (ASIC), field-programmable gate array (FPGA), or may comprise a combination of executable software instructions and circuitry.

The computing device 12-1 includes a function identifier 102 that is operable to identify in the first QIF a first function identifier that identifies a first function of a plurality of functions. The function identifier 102 may comprise executable software instructions configured to program a processor device to implement the functionality of identifying in the first QIF a first function identifier that identifies a first function of a plurality of functions, may comprise circuitry including, by way of non-limiting example, an application-specific integrated circuit (ASIC), field-programmable gate array (FPGA), or may comprise a combination of executable software instructions and circuitry.

The computing device 12-1 includes a programming instruction set obtainer 104 that is operable to obtain, from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions. The programming instruction set obtainer 104 may comprise executable software instructions configured to program a processor device to implement the functionality of obtaining, from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions, may comprise circuitry including, by way of non-limiting example, an application-specific integrated circuit (ASIC), field-programmable gate array (FPGA), or may comprise a combination of executable software instructions and circuitry.

The computing device 12-1 includes a QIF modifier 106 that is operable to modify the first QIF to include the first programming instruction set at a location associated with the first function identifier in the first QIF to generate a first modified QIF. The QIF modifier 106 may comprise executable software instructions configured to program a processor device to implement the functionality of modifying the first QIF to include the first programming instruction set at a location associated with the first function identifier in the first QIF to generate a first modified QIF, may comprise circuitry including, by way of non-limiting example, an application-specific integrated circuit (ASIC), field-programmable gate array (FPGA), or may comprise a combination of executable software instructions and circuitry.

The computing device 12-1 includes a QIF submitter 108 that is operable to cause the first modified QIF to be submitted to the first QCS for execution in lieu of the first QIF. The QIF submitter 108 may comprise executable software instructions configured to program a processor device to implement the functionality of causing the first modified QIF to be submitted to the first QCS for execution in lieu of the first QIF, may comprise circuitry including, by way of non-limiting example, an application-specific integrated circuit (ASIC), field-programmable gate array (FPGA), or may comprise a combination of executable software instructions and circuitry.

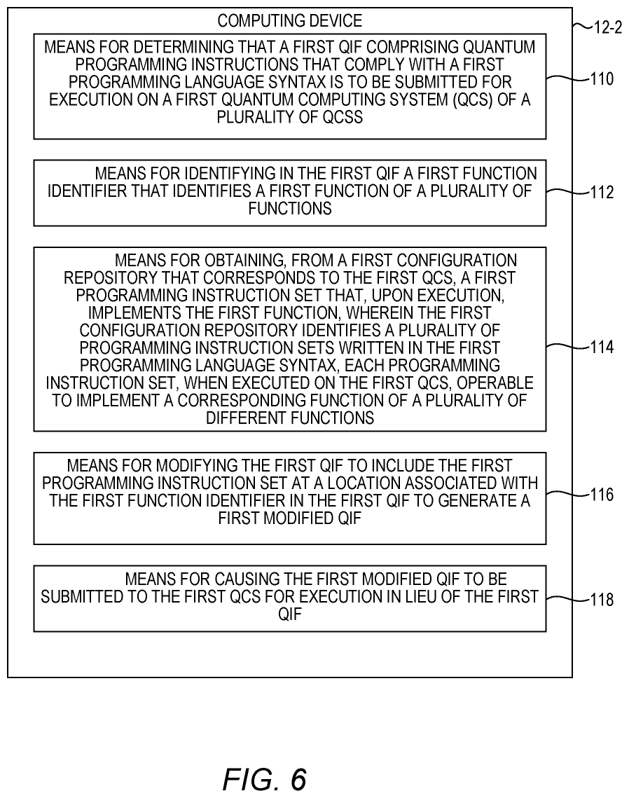

FIG. 6 is a block diagram of a computing device 12-2 according to additional implementations. The computing device 12-2 implements identical functionality as that described above with regard to the computing device 12. In this implementation, the computing device 12-2 includes a means 110 for determining that a first QIF comprising quantum programming instructions that comply with a first programming language syntax is to be submitted for execution on a first quantum computing system (QCS) of a plurality of QCSs. The means 110 may be implemented in any number of manners, including, for example, via the QIF determiner 100 illustrated in FIG. 5. The means 110 may, in some implementations, be implemented via the QIF customizer 36 as discussed above. The means 110 may include receiving information from a QIF scheduler that identifies the first QIF. The means 110 may include receiving information from a primary container that comprises a request to a QIF scheduler to submit the first QIF to a QCS

The computing device 12-2 further includes a means 112 for identifying in the first QIF a first function identifier that identifies a first function of a plurality of functions. The means 112 may be implemented in any number of manners, including, for example, via the function identifier 102 illustrated in FIG. 5. The means 112 may, in some implementations, be implemented via the QIF customizer 36 as discussed above. The means 112 may include, for example, parsing the first QIF to find predefined function identifiers.

The computing device 12-2 further includes a means 114 for obtaining, from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions. The means 114 may be implemented in any number of manners, including, for example, via the programming instruction set obtainer 104 illustrated in FIG. 5. The means 114 may, in some implementations, be implemented via the QIF customizer 36 as discussed above. The means 114 may, for example, determining that a particular configuration structure of a plurality of configuration structures should be used based on the particular QCS to which the first QIF will be submitted, and a programming language in which the first QIF has been programmed.

The computing device 12-2 further includes a means 116 for modifying the first QIF to include the first programming instruction set at a location associated with the first function identifier in the first QIF to generate a first modified QIF. The means 116 may be implemented in any number of manners, including, for example, via the QIF modifier 106 illustrated in FIG. 5. The means 116 may, in some implementations, be implemented via the QIF customizer 36 as discussed above. The means 116 may include, for example, replacing identified function identifiers with corresponding programming instruction sets from the configuration structure. The means 116 may include, for example, inserting the corresponding programming instruction sets from the configuration structure at a location with respect to the identified function identifiers, such as immediately preceding the function identifier or immediately after the function identifier.

The computing device 12-2 further includes a means 118 for causing the first modified QIF to be submitted to the first QCS for execution in lieu of the first QIF. The means 118 may be implemented in any number of manners, including, for example, via the QIF submitter 108 illustrated in FIG. 5. The means 118 may, in some implementations, be implemented via the QIF customizer 36 as discussed above. The means 118 may, in some implementations, include sending the first modified QIF to the QIF scheduler for submission to the QCS. The means 118 may, in other implementations, include sending the first modified QIF directly to the QCS.

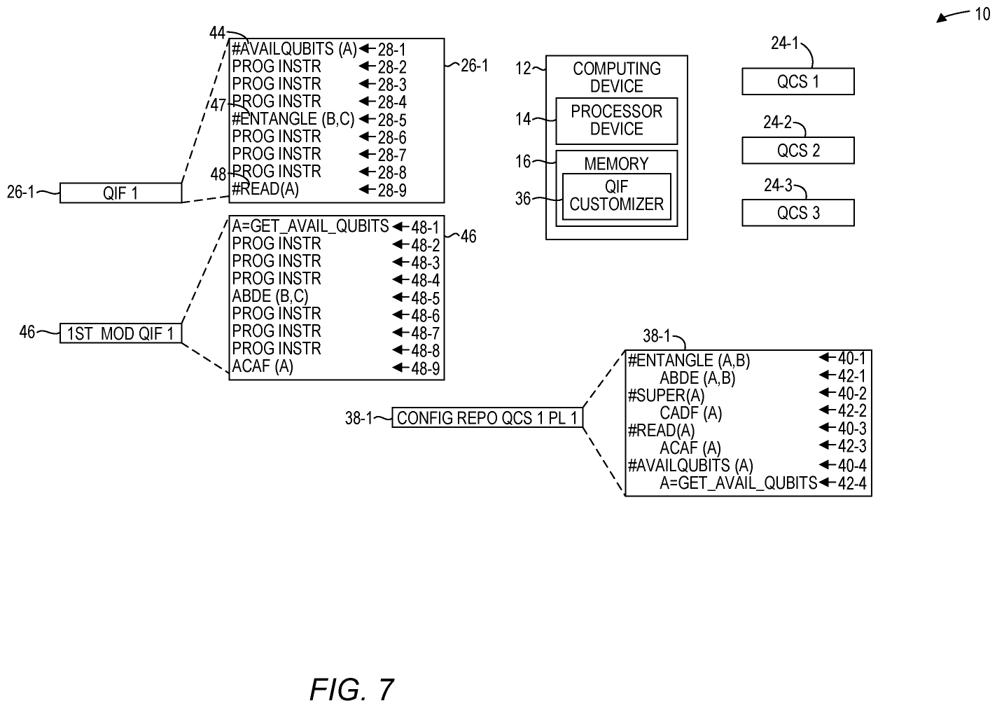

FIG. 7 is a simplified block diagram of the environment 10 illustrated in FIG. 1 according to one implementation. The environment 10 includes the computing device 12, which in turn includes the memory 16 and the processor device 14. The processor device 14 is coupled to the memory 16 to determine that the QIF 26-1 that includes quantum programming instructions is to be submitted for execution on the QCS 24-1 of the plurality of QCSs 24. The processor device 14 is further to identify in the QIF 26-1 the function identifier 44 that identifies a quantum function of a plurality of quantum functions. The processor device 14 is further to obtain, from the configuration structure 38-1, the programming instruction set 42-4 that implements the quantum function. The processor device 14 is further to modify the QIF 26-1 to include the programming instruction set to generate the modified QIF 46, and cause the modified QIF 46 to be submitted to the QCS 24-1 for execution in lieu of the QIF 26-1.

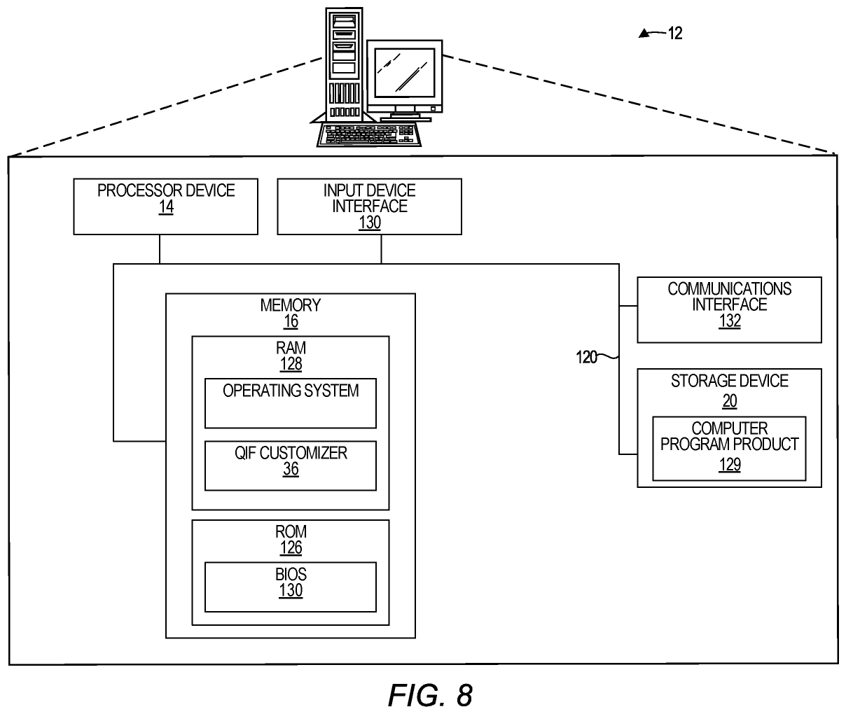

FIG. 8 is a block diagram of the computing device 12 suitable for implementing examples according to one example. The computing device 12 may comprise any computing or electronic device capable of including firmware, hardware, and/or executing software instructions to implement the functionality described herein, such as a computer server, a desktop computing device, a laptop computing device, or the like. The computing device 12 includes the processor device 14, the system memory 16, and a system bus 120. The system bus 120 provides an interface for system components including, but not limited to, the system memory 16 and the processor device 14. The processor device 14 can be any commercially available or proprietary processor.

The system bus 120 may be any of several types of bus structures that may further interconnect to a memory bus (with or without a memory controller), a peripheral bus, and/or a local bus using any of a variety of commercially available bus architectures. The system memory 16 may include non-volatile memory 126 (e.g., read-only memory (ROM), erasable programmable read-only memory (EPROM), electrically erasable programmable read-only memory (EEPROM), etc.), and volatile memory 128 (e.g., random-access memory (RAM)). A basic input/output system (BIOS) 130 may be stored in the non-volatile memory 126 and can include the basic routines that help to transfer information between elements within the computing device 12. The volatile memory 128 may also include a high-speed RAM, such as static RAM, for caching data.

The computing device 12 may further include or be coupled to a non-transitory computer-readable storage medium such as the storage device 20, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 20 and other drives associated with computer-readable media and computer-usable media may provide non-volatile storage of data, data structures, computer-executable instructions, and the like.

A number of modules can be stored in the storage device 20 and in the volatile memory 128, including an operating system and one or more program modules, such as the QIF customizer 36, which may implement the functionality described herein in whole or in part. All or a portion of the examples may be implemented as a computer program product 129 stored on a transitory or non-transitory computer-usable or computer-readable storage medium, such as the storage device 20, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the QIF customizer 36 in the volatile memory 128, may serve as a controller, or control system, for the computing device 12 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 14 through an input device interface 130 that is coupled to the system bus 120 but can be connected by other interfaces such as a parallel port, an Institute of Electrical and Electronic Engineers (IEEE) 1394 serial port, a Universal Serial Bus (USB) port, an IR interface, and the like. The computing device 12 may also include a communications interface 132 suitable for communicating with a network as appropriate or desired.

Other computer system designs and configurations may also be suitable to implement the systems and methods described herein. The following examples illustrate various additional implementations in accordance with one or more aspects of the disclosure.

Example 1 is an apparatus comprising: means for determining that a first QIF comprising quantum programming instructions that comply with a first programming language syntax is to be submitted for execution on a first quantum computing system (QCS) of a plurality of QCSs; means for identifying in the first QIF a first function identifier that identifies a first function of a plurality of functions; means for obtaining, from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions; means for modifying the first QIF to include the first programming instruction set at a location associated with the first function identifier in the first QIF to generate a first modified QIF; and means for causing the first modified QIF to be submitted to the first QCS for execution in lieu of the first QIF.

Example 2 is the apparatus of example 1 wherein the means for determining that the first QIF comprising quantum programming instructions that comply with the first programming language syntax is to be submitted for execution on the first QCS of the plurality of QCSs further comprises: means for receiving, from a QIF scheduler, an indication that the first QIF is to be submitted for execution to the first QCS; and wherein the means for causing the first modified QIF to be submitted to the first QCS for execution in lieu of the first QIF further comprises means for sending, to the QIF scheduler, information that identifies the first modified QIF.

Example 3 is an apparatus comprising: a quantum instruction file (QIF) determiner to determine that a first QIF comprising quantum programming instructions that comply with a first programming language syntax is to be submitted for execution on a first quantum computing system (QCS) of a plurality of QCSs; a function identifier to identify in the first QIF a first function identifier that identifies a first function of a plurality of functions; a programming instruction set obtainer to obtain, from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions; a QIF modifier to modify the first QIF to include the first programming instruction set at a location associated with the first function identifier in the first QIF to generate a first modified QIF; and a QIF submitter to cause the first modified QIF to be submitted to the first QCS for execution in lieu of the first QIF.

Example 4 is the apparatus of example 3 wherein the QIF determiner is further to receive, from a QIF scheduler, an indication that the first QIF is to be submitted for execution to the first QCS; and wherein the QIF submitter is further to send, to the QIF scheduler, information that identifies the first modified QIF.

Example 5 is a method comprising: receiving, by a quantum instruction file (QIF) scheduler, a first QIF for submission for execution on a first quantum computing system (QCS) of a plurality of QCSs, the first QIF comprising quantum programming instructions that comply with a first programming language syntax is to be submitted for execution on the first QCS of the plurality of QCSs; identifying in the first QIF, by the QIF scheduler, a first function identifier that identifies a first function of a plurality of functions; obtaining, by the QIF scheduler from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions; modifying, by the QIF scheduler, the first QIF to include the first programming instruction set at a location associated with the first function identifier in the first QIF to generate a first modified QIF; and submitting, by the QIF scheduler, the first modified QIF to the first QCS for execution in lieu of the first QIF.

Example 6 is the method of example 5 wherein determining that the first QIF comprising the quantum programming instructions is to be submitted for execution on the first QCS comprises receiving, by QIF scheduler, an indication that the first QIF is to be submitted for execution to the first QCS.

Example 7 is the method of example 5 further comprising: determining, by the QIF scheduler, a first programming language of a plurality of different programming languages that utilizes the first programming language syntax; and selecting, by the QIF scheduler, the first configuration structure from a plurality of configuration repositories that correspond to the first QCS based on determining the first programming language.

Example 8 is the method of example 5 further comprising: determining, by the QIF scheduler, that the first QIF is to be submitted for execution on a second QCS of the plurality of QCSs; identifying in the QIF, by the QIF scheduler, the first function identifier that identifies the first function of the plurality of functions; obtaining, by the QIF scheduler from a second configuration structure that corresponds to the second QCS, a second programming instruction set that, upon execution, implements the first function, wherein the second programming instruction set is different from the first programming instruction set; modifying, by the QIF scheduler, the first QIF to include the second programming instruction set at the location associated with the first function identifier in the first QIF to generate a second modified QIF; and submitting, by the QIF scheduler, the second modified QIF to the second QCS for execution in lieu of the first QIF.

Example 9 is an apparatus comprising: a memory; and a processor device coupled to the memory to: receive a first QIF for submission for execution on a first quantum computing system (QCS) of a plurality of QCSs, the first QIF comprising quantum programming instructions that comply with a first programming language syntax is to be submitted for execution on the first QCS of the plurality of QCSs; identify in the first QIF a first function identifier that identifies a first function of a plurality of functions; obtain, from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions; modify the first QIF to include the first programming instruction set at a location associated with the first function identifier in the first QIF to generate a first modified QIF; and submit the first modified QIF to the first QCS for execution in lieu of the first QIF.

Example 10 is the apparatus of example 9 wherein, to determine that the first QIF comprising the quantum programming instructions is to be submitted for execution on the first QCS, the processor device is further to receive an indication that the first QIF is to be submitted for execution to the first QCS.

Example 11 is the apparatus of example 9 wherein the processor device is further to: determine a first programming language of a plurality of different programming languages that utilizes the first programming language syntax; and select the first configuration structure from a plurality of configuration repositories that correspond to the first QCS based on determining the first programming language.

Example 12 is the apparatus of example 9 wherein the processor device is further to: determine that the first QIF is to be submitted for execution on a second QCS of the plurality of QCSs; identify in the QIF the first function identifier that identifies the first function of the plurality of functions; obtain, from a second configuration structure that corresponds to the second QCS, a second programming instruction set that, upon execution, implements the first function, wherein the second programming instruction set is different from the first programming instruction set; modify the first QIF to include the second programming instruction set at the location associated with the first function identifier in the first QIF to generate a second modified QIF; and submit the second modified QIF to the second QCS for execution in lieu of the first QIF.

Example 13 is a method comprising: receiving, by a control plane of a container orchestration system, a pod manifest for initiation on a worker node of a cluster of worker nodes; detecting, by the control plane in the pod manifest, a predefined sequence of characters; in response to detecting the predefined sequence of characters, modifying the pod manifest to include a reference to a QIF customizer container image, the QIF customizer container image, when initiated as a QIF customizer container, operable to modify a quantum instruction file (QIF) comprising quantum programming instructions that comply with a first programming language syntax to include a programming instruction set that when executed on a quantum computing system (QCS), is operable to implement a corresponding function of a plurality of different functions that is identified in the QIF.

Example 14 is the method of example 13 further comprising: causing, by the control plane, the initiation of a pod on a worker node, and the initiation of the QIF customizer container from the QIF customizer container image.

Example 15 is an apparatus comprising: a memory; and a processor device coupled to the memory to: receive, by a control plane of a container orchestration system, a pod manifest for initiation on a worker node of a cluster of worker nodes; detect, by the control plane in the pod manifest, a predefined sequence of characters; in response to detecting the predefined sequence of characters, modify the pod manifest to include a reference to a quantum instruction file (QIF) customizer container image, the QIF customizer container image, when initiated as a QIF customizer container, operable to modify a QIF comprising quantum programming instructions that comply with a first programming language syntax to include a programming instruction set that when executed on a quantum computing system (QCS), is operable to implement a corresponding function of a plurality of different functions that is identified in the QIF.

Example 16 is the apparatus of example 15 wherein the processor device is further to cause, by the control plane, the initiation of a pod on a worker node, and the initiation of the QIF customizer container from the QIF customizer container image.

Example 17 is a method comprising: determining, by a quantum instruction file (QIF) customizer sidecar container executing in a pod initiated by a container orchestration system, that a primary container executing in the pod desires to submit a first QIF comprising quantum programming instructions that comply with a first programming language syntax to a first quantum computing system (QCS); identifying in the first QIF, by the QIF customizer sidecar container, a first function identifier that identifies a first function of a plurality of functions; obtaining, by the QIF customizer sidecar container from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions; modifying, by the QIF customizer sidecar container, the first QIF to include the first programming instruction set at a location associated with the first function identifier in the first QIF to generate a first modified QIF; and causing, by the QIF customizer sidecar container, the first modified QIF to be submitted to the first QCS for execution in lieu of the first QIF.

Example 18 is the method of example 17 wherein determining that the primary container executing in the pod desires to submit the first QIF to the first QCS comprises: intercepting, by the QIF customizer sidecar container, a message sent by the primary container to a QIF scheduler, a request to submit the first QIF to the first QCS; and inhibiting, by the QIF customizer sidecar container, the message from being sent to the QIF scheduler.

Example 19 is an apparatus comprising: a memory; and a processor device coupled to the memory to: determine, by a quantum instruction file (QIF) customizer sidecar container executing in a pod initiated by a container orchestration system, that a primary container executing in the pod desires to submit a QIF comprising quantum programming instructions that comply with a first programming language syntax to a first quantum computing system (QCS); identify in the first QIF, by the QIF customizer sidecar container, a first function identifier that identifies a first function of a plurality of functions; obtain, by the QIF customizer sidecar container from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions; modify, by the QIF customizer sidecar container, the first QIF to include the first programming instruction set at a location associated with the first function identifier in the first QIF to generate a first modified QIF; and cause, by the QIF customizer sidecar container, the first modified QIF to be submitted to the first QCS for execution in lieu of the first QIF.

Example 20 is the apparatus of example 19 wherein, to determine that the primary container executing in the pod desires to submit the first QIF to the first QCS, the processor device is further to: intercept, by the QIF customizer sidecar container, a message sent by the primary container to a QIF scheduler, a request to submit the first QIF to the first QCS; and inhibit, by the QIF customizer sidecar container, the message from being sent to the QIF scheduler.

Individuals will recognize improvements and modifications to the preferred examples of the disclosure. All such improvements and modifications are considered within the scope of the concepts disclosed herein and the claims that follow.

What is claimed is:

1. A method comprising:
determining, by a quantum instruction file (QIF) customizer executing on a computing device, that a first QIF comprising quantum programming instructions that comply with a first programming language syntax is to be submitted for execution on a first quantum computing system (QCS) of a plurality of QCSs;
identifying in the first QIF, by the QIF customizer, a first function identifier that identifies a first function of a plurality of functions;
obtaining, by the QIF customizer from a first configuration structure that corresponds to the first QCS, a first programming instruction set that, upon execution, implements the first function, wherein the first configuration structure identifies a plurality of programming instruction sets written in the first programming language syntax, each programming instruction set, when executed on the first QCS, operable to implement a corresponding function of a plurality of different functions;
modifying, by the QIF customizer, the first QIF to include the first programming instruction set at a location associated with the first function identifier in the first QIF to generate a first modified QIF; and
causing, by the QIF customizer, the first modified QIF to be submitted to the first QCS for execution in lieu of the first QIF.

2. The method of claim 1 wherein determining that the first QIF comprising the quantum programming instructions is to be submitted for execution on the first QCS comprises:
receiving, by the QIF customizer from a QIF scheduler, an indication that the first QIF is to be submitted for execution to the first QCS; and
wherein causing, by the QIF customizer, the first modified QIF to be submitted to the first QCS for execution in lieu of the first QIF comprises sending, by the QIF customizer to the QIF scheduler, information that identifies the first modified QIF.

3. The method of claim 1 wherein the QIF customizer is a component of a QIF scheduler that is operable to schedule QIFs for execution on one of the plurality of QCSs based on a criterion, and further comprising:
receiving, by the QIF scheduler, a reference to the first QIF;
accessing QCS metadata that identifies characteristics of each of the QCSs; and
determining that the first QIF is to be submitted for execution on the first QCS based at least in part on the QCS metadata.

4. The method of claim 3 further comprising:
wherein determining that the first QIF is to be submitted for execution on the first QCS based at least in part on the QCS metadata further comprises determining, based on the QCS metadata by the QIF scheduler, that the first QCS has fewer QIFs queued for execution than any other QCS of the plurality of QCSs.

5. The method of claim 3 further comprising:
wherein determining that the first QIF is to be submitted for execution on the first QCS based at least in part on the QCS metadata further comprises determining, based on the QCS metadata by the QIF scheduler, that the first QCS has a lower memory utilization than a memory utilization of any other QCS of the plurality of QCSs.

6. The method of claim 3 further comprising:
wherein determining that the first QIF is to be submitted for execution on the first QCS based at least in part on the QCS metadata further comprises determining, based on the QCS metadata by the QIF scheduler, that the first QCS has a larger number of available qubits than a number of available qubits of any other QCS of the plurality of QCSs.

7. The method of claim 1 further comprising:
determining, by the QIF customizer, a first programming language of a plurality of different programming languages that utilizes the first programming language syntax; and
selecting, by the QIF customizer, the first configuration structure from a plurality of configuration structures that correspond to the first QCS based on determining the first programming language.

8. The method of claim 7 wherein each configuration structure of the plurality of configuration structures that correspond to the first QCS corresponds to a different programming language.

9. The method of claim 1 wherein identifying the first function identifier that identifies the first function of the plurality of functions further comprises:
parsing, by the QIF customizer, the first QIF; and
determining, based on the parsing, that the first function identifier matches a predefined sequence of characters contained in a set of a plurality of predefined sequences of characters.

10. The method of claim 1 wherein modifying, by the QIF customizer, the first QIF to include the first programming instruction set at the location associated with the first function identifier in the first QIF to generate the first modified QIF further comprises replacing the first function identifier with the first programming instruction set.

11. The method of claim 1 wherein modifying, by the QIF customizer, the first QIF to include the first programming instruction set at the location associated with the first function identifier in the first QIF to generate the first modified QIF further comprises inserting the first programming instruction set at a location immediately following the first function identifier.

12. The method of claim 1 further comprising:
determining, by the QIF customizer, that the first QIF is to be submitted for execution on a second QCS of the plurality of QCSs;
identifying in the first QIF, by the QIF customizer, the first function identifier that identifies the first function of the plurality of functions;
obtaining, by the QIF customizer from a second configuration structure that corresponds to the second QCS, a second programming instruction set that, upon execution, implements the first function, wherein the second programming instruction set is different from the first programming instruction set;
modifying, by the QIF customizer, the first QIF to include the second programming instruction set at the location associated with the first function identifier in the first QIF to generate a second modified QIF; and
causing, by the QIF customizer, the second modified QIF to be submitted to the second QCS for execution in lieu of the first QIF.

13. The method of claim 1 further comprising:
obtaining, by the QIF customizer, QCS metadata that identifies characteristics of the first QCS; and
based on the QCS metadata, modifying the first configuration structure.

14. The method of claim 13 wherein modifying the first configuration structure comprises modifying a second programming instruction set that, upon execution, implements a second function.

15. The method of claim 1 wherein the first function comprises putting a qubit into a state of superposition.

16. The method of claim 1 wherein the first function comprises causing two qubits to be entangled.

17. The method of claim 1 further comprising:
identifying in the first QIF, by the QIF customizer, a second function identifier that identifies a second function of the plurality of functions;
obtaining, by the QIF customizer from the first configuration structure, a second programming instruction set that, upon execution, implements the second function; and
modifying, by the QIF customizer, the first QIF to include the second programming instruction set at a location associated with the second function identifier in the first QIF to generate the first modified QIF.

18. A computing device, comprising:
a memory; and
a processor device coupled to the memory to:
determine that a quantum instruction file (QIF) comprising quantum programming instructions is to be submitted for execution on a quantum computing system (QCS) of a plurality of QCSs;
identify in the QIF a function identifier that identifies a quantum function of a plurality of quantum functions;
obtain, from a configuration structure, a programming instruction set that implements the quantum function;
modify the QIF to include the programming instruction set to generate a modified QIF; and
cause the modified QIF to be submitted to the QCS for execution in lieu of the QIF.

19. The computing device of claim 18 wherein to determine that the QIF is to be submitted for execution on the QCS, the processor device is further to:
receive, from a QIF scheduler, an indication that the QIF is to be submitted for execution to the QCS; and
wherein to cause the modified QIF to be submitted to the QCS for execution, the processor device is further to send, to the QIF scheduler, information that identifies the modified QIF.

20. A non-transitory computer-readable storage medium that includes executable instructions to cause a processor device to:
determine that a quantum instruction file (QIF) comprising quantum programming instructions that comply with a programming language syntax is to be submitted for execution on a quantum computing system (QCS) of a plurality of QCSs;
identify in the QIF a function identifier that identifies a function of a plurality of functions;
obtain, from a configuration structure, a programming instruction set that, upon execution, implements the function, wherein the configuration structure identifies a plurality of programming instruction sets written in the programming language syntax and being operable to implement a corresponding function of a plurality of different functions;
modify the QIF to include the programming instruction set at a location associated with the function identifier in the QIF to generate a modified QIF; and
cause the modified QIF to be submitted to the QCS for execution.
